(19) United States
(12) Patent Application Publication
(10) Pub. No.: US 2013/0067971 A1
(43) Pub. Date: Mar. 21, 2013

(54) Zipper Lock

(71) Applicant: Wen-Cheng Huang, Kuanshan City (CN)

(72) Inventor: Wen-Cheng Huang, Kuanshan City (CN)

(73) Assignee: SINOX LOCK (KUNSHAN) CO., LTD., Kunshan City (CN)

(21) Appl. No.: 13/621,996

(22) Filed: Sep. 18, 2012

Related U.S. Application Data
(60) Provisional application No. 61/536,386, filed on Sep. 19, 2011.

(51) Int. Cl. E05B 65/52

(52) U.S. Cl. 70/286; 70/266; 70/344

(57) ABSTRACT

A zipper lock contains: a lock body, a lock mechanism, and a shackle. The lock body includes at least one positioning post mounted thereon for fitting with at least one pull piece by using at least one through hole of the at least one pull piece. The lock mechanism is disposed on the lock body. The shackle is axially connected with the lock body and is rotated toward a unlock position relative to the lock body so that the at least one pull piece is fitted onto and removed from the at least one positioning post. The shackle allows being rotated toward a lock position relative to the lock body so that the at least one pull piece is fitted onto the at least one positioning post, and the shackle is locked by the lock mechanism.

### FIELD OF THE INVENTION

The present invention relates to a zipper lock, and more particularly to a zipper lock which is fixed on of a bag with zippers so as to lock at least one pull piece.

### BACKGROUND OF THE INVENTION

A conventional zipper lock is applied to lock the pull piece and is designed in two different types. For example, a zipper lock has a lock mechanism connecting with a first zipper having a first pull piece, and a second zipper having a second pull piece is moved closed to the first zipper so that the lock mechanism locks the first pull piece of the first zipper and the second pull piece of the second zipper together. Another type of zipper lock is fixed on a bag and close to a zipper. This zipper lock includes a receiving groove to receive a pull piece and a lock mechanism to lock the pull piece on a fastener so that the pull piece and its head end can not be moved.

In operation, the pull piece of the zipper lock has to be placed in the receiving groove exactly, and then the lock mechanism locks the pull piece.

However, when the bag has a plurality of zippers (such as two zippers) attached thereon, then two receiving grooves have to be defined on the zipper lock for receiving two pull pieces of the two zippers, and a fastener has to lock the two pull pieces simultaneously, thus having a complicated locking structure and operation.

The present invention has arisen to mitigate and/or obviate the afore-described disadvantages.

### SUMMARY OF THE INVENTION

The primary object of the present invention is to provide a zipper lock which is fixed on of a bag with zippers so as to lock at least one pull piece easily.

To obtain the above objective, a zipper lock provided by the present invention contains:

a lock body including at least one positioning post mounted thereon for fitting with at least one pull piece by using at least one through hole of the at least one pull piece;

a lock mechanism disposed on the lock body;

a shackle axially connected with the lock body and rotated toward a unlock position relative to the lock body so that the at least one pull piece is fitted onto and removed from the at least one positioning post, and the shackle allowing being rotated toward a lock position relative to the lock body so that the at least one pull piece is fitted onto the at least one positioning post, and the shackle is locked by the lock mechanism.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view showing a shackle of a zipper lock of a preferred embodiment of the present invention located at a unlock position.

FIG. 2 is another perspective view showing the shackle of the zipper lock of the preferred embodiment of the present invention located at a unlock position.

FIG. 3 is a perspective view showing the shackle of the zipper lock of the preferred embodiment of the present invention located at a lock position.

FIG. 4 is a partially cross sectional view showing the shackle of the zipper lock of the preferred embodiment of the present invention located at the unlock position.

FIG. 5 is a cross sectional view showing the assembly of the zipper lock of the preferred embodiment of the present invention and the shackle located at the lock position.

FIG. 6 is a cross sectional view showing a shackle of a zipper lock according to another preferred embodiment of the present invention.

FIG. 7 is a perspective view showing only one positioning post of the present invention fixed on the lock body.

### DETAILED DESCRIPTION OF THE PREFERRED EMBODIMENTS

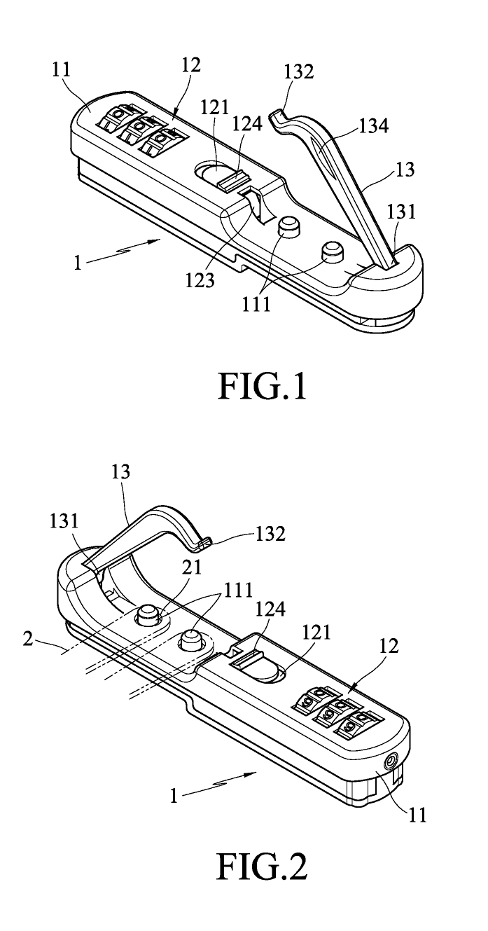

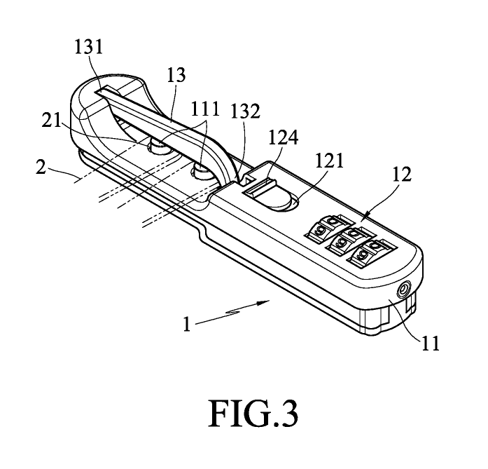

FIGS. 1-2 are a perspective view showing a shackle of a zipper lock of a preferred embodiment of the present invention located at a unlock position. FIG. 3 is a perspective view showing the shackle of the zipper lock of the preferred embodiment of the present invention located at a lock position. With reference to FIGS. 1-3, a zipper lock according to the present invention comprises a lock body 11, a lock mechanism 12 disposed on the lock body 11, a shackle 13 axially connected with the lock body 11, wherein the shackle 13 allows being moved to a unlock position (as shown in

FIGS. 1 and 2) and a lock position (as illustrated in FIG. 3) relative to the lock body 11.

The lock body 11 includes at least one positioning post 111 mounted thereon for fitting with at least one pull piece 2 by using at least one through hole 21 of the at least one pull piece 2.

In this embodiment, the lock mechanism 12 is a combination lock mechanism capable of being shifted to a unlock state or a lock state by changing a set code. In another embodiment, the lock mechanism 12 is a key lock mechanism with a keyhole.

The shackle 13 includes a connecting end 131 axially coupled with the lock body 11 and a free end 132 locked by the lock mechanism 12. The shackle 13 allows being rotated toward a unlock position relative to the lock body 1 so that the at least one pull piece 2 is fitted onto and removed from the at least one positioning post 111. Also, the shackle 13 allows being rotated toward a lock position relative to the lock body 1 so that the at least one pull piece 2 is fitted onto the at least one positioning post 111, and the shackle 13 is locked by the lock mechanism 12.

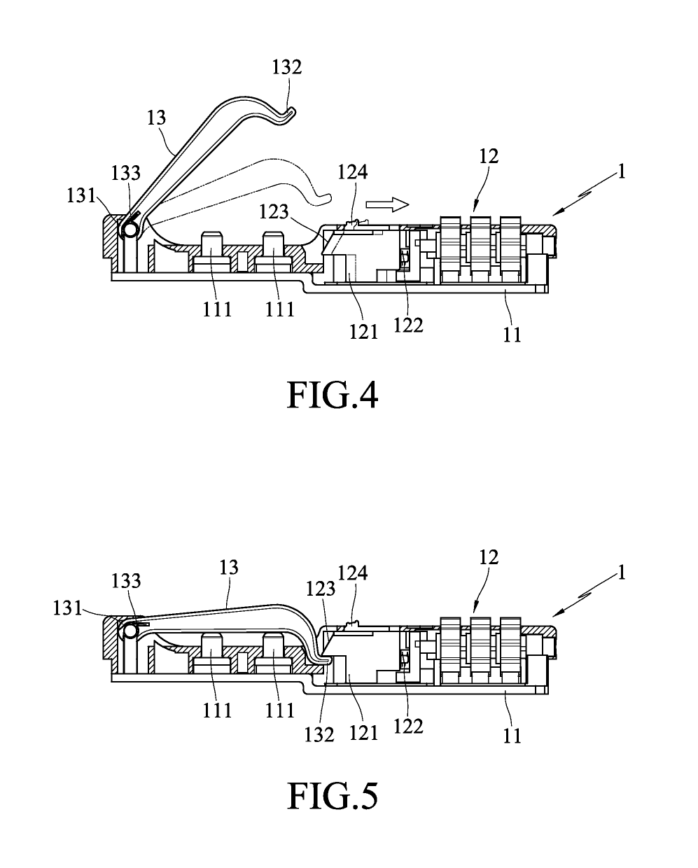

FIG. 4 is a partially cross sectional view showing the shackle of the zipper lock of the preferred embodiment of the present invention located at the unlock position. The lock mechanism 12 further includes a movable fastener 121 for locking the shackle 13 which is at the lock position. When the movable fastener 121 aligns with the shackle 13 at the lock position, the movable fastener 121 locks the shackle 13 at a fasten position (as shown by a solid line in FIG. 4) and unlocks the shackle 13 at a unfasten position (as shown by a dotted line in FIG. 4).

FIG. 5 is a cross sectional view showing the assembly of the zipper lock of the preferred embodiment of the present invention and the shackle located at the lock position. As shown in FIGS. 4 and 5, the movable fastener 121 is pushed by a push spring 122 so as to be located at the fasten position, and the movable fastener 121 has a tilted guide face 123 so that when the shackle 13 moves from the unlock position to the unlock position, the free end 132 of the shackle 13 contacts with the tilted guide face 123 and pushes the movable fastener 121 to move from the fasten position to the unfasten position, and then after the shackle 13 moves to the lock position, the movable fattener 121 returns back to the fasten position.

When the shackle 13, locked at the lock position, is locked by the movable fastener 121, a set code of the lock mechanism 12 is changed so that the lock mechanism 12 is in the lock state, and then the movable fastener 121 is locked at the fasten position without being pushed, thus locking the shackle 13 at the lock position and fixing the at least one pull piece 2 on the at least one positioning post 111.

As desiring to remove the at least one pull piece 2 from the at least one positioning post 111, the set code of the lock mechanism 12 is changed so that the lock mechanism 12 is in the unlock state, and then the movable fastener 121 is pushed to the unfasten position, such that the shackle 13 moves away from the lock position and returns back to the unlock position, thus removing the at least one pull piece 2 from the at least one positioning post 111.

The movable fastener 121 has an actuation block 124 extends out of the lock body 11 and used to push the move fastener 121. The connecting end 131 of the shackle 13 has a returning spring 133 fixed thereon so that when the shackle 13 is not locked, the returning spring 133 pushes the shackle 13 to the unlock position. Or the shackle 13 has a recess 134 defined thereon so that a user moves the shackle 13 by pulling the recess 134.

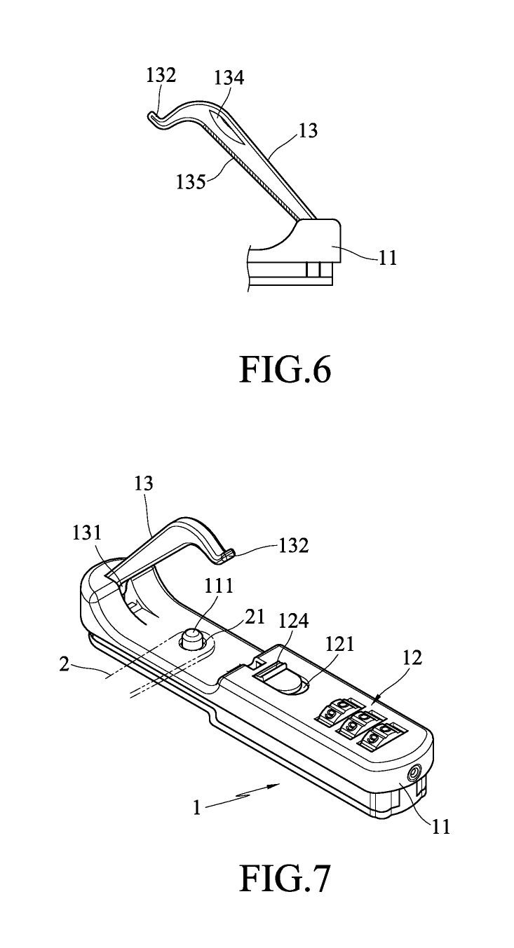

FIG. 6 is a cross sectional view showing a shackle of a zipper lock according to another preferred embodiment of the present invention. The shackle 13 is used not only to limit the at least one pull piece 2 but also to cut objects by providing a cutting portion 135 at a suitable position of the shackle 13.

Thereby, no matter one or two zipper heads are fixed on the zipper, the zipper lock 1 of the present invention allows increasing or decreasing the at least one positioning post 111 based on using requirement without adding other components. FIG. 7 is a perspective view showing only one positioning post fixed on the lock body. It is to be noted that the positioning post 111 also allows being used to fit with two pull pieces 2 which overlap together.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A zipper lock comprises:
a lock body including at least one positioning post mounted thereon for fitting with at least one pull piece by using at least one through hole of the at least one pull piece;
a lock mechanism disposed on the lock body;
a shackle axially connected with the lock body and rotated toward a unlock position relative to the lock body so that the at least one pull piece is fitted onto and removed from the at least one positioning post, and the shackle allowing being rotated toward a lock position relative to the lock body so that the at least one pull piece is fitted onto the at least one positioning post, and the shackle is locked by the lock mechanism.

2. The zipper lock as claimed in claim 1, wherein the lock mechanism is a combination lock mechanism.

3. The zipper lock as claimed in claim 1, wherein the lock mechanism is a key lock mechanism.

4. The zipper lock as claimed in claim 1, wherein the lock mechanism further includes a movable fastener for locking the shackle which is at the lock position.

5. The zipper lock as claimed in claim 4, wherein the shackle includes a connecting end axially coupled with the lock body and a free end locked by the lock mechanism.

6. The zipper lock as claimed in claim 4, wherein when the movable fastener aligns with the shackle at the lock position, the movable fastener locks the shackle at a fasten position and unlocks the shackle at a unfasten position.

7. The zipper lock as claimed in claim 6, wherein the movable fastener has a tilted guide face so that when the shackle moves from the unlock position to the unlock position, the free end of the shackle contacts with the tilted guide face and pushes the movable fastener to move from the fasten position to the unfasten position, and then after the shackle moves to the lock position, the movable fattener returns back to the fasten position.

8. The zipper lock as claimed in claim 6, wherein the movable fastener is pushed by a push spring so as to be located at the fasten position

9. The zipper lock as claimed in claim 4, wherein the movable fastener has an actuation block extends out of the lock body.

10. The zipper lock as claimed in claim 1, wherein the shackle includes a connecting end axially coupled with the lock body and a free end locked by the lock mechanism, and the connecting end of the shackle has a returning spring fixed thereon so as to pushes the shackle to the unlock position.

11. The zipper lock as claimed in claim 1, wherein the shackle has a recess defined thereon.

12. The zipper lock as claimed in claim 1, wherein the shackle has a cutting potion fixed thereon.
